(19) United States
(12) Patent Application Publication
(10) Pub. No.: US 2021/0065944 A1
(43) Pub. Date: Mar. 4, 2021

(54) CORE FOR A TRANSFORMER

(71) Applicant: SIEMENS AKTIENGESELLSCHAFT, MUENCHEN (DE)

(72) Inventor: STEPHAN VOSS, Neunkirchen am Brand (DE)

(21) Appl. No.: 16/977,170

(22) PCT Filed: Mar. 1, 2019
(86) PCT No.: PCT/EP2019/055188

§ 371 Date: Sep. 1, 2020

(30) Foreign Application Priority Data
Mar. 1, 2018 (DE) 10 2018 203 087

(51) Int. Cl. H01F 3/14; H01F 27/245; H01F 27/255; H01F 41/02

(52) U.S. Cl. CPC H01F 3/14; H01F 41/024; H01F 27/255; H01F 27/2455

(57) ABSTRACT

A core for a transformer includes a multiplicity of bent metal sheets that are all connected to form a structure which surrounds a core opening and forms the core. The sheet ends of each of the metal sheet do not touch one another within the core. The metal sheets together with the core form at least one air gap at the respective sheet ends within the core or at a periphery of the core. The core is impregnated or coated, at least at the sheet ends of the metal sheets, with a lacquer or coating that contains magnetic particles. The impregnation or coating fills at least the air gaps at the sheet ends of the metal sheets. A method for producing a transformer having a core is also provided.

The present invention relates to a core for a transformer that comprises a plurality of bent metal sheets that are all bonded to form a structure that surrounds a core opening and forms the core, wherein in each case the sheet ends of each metal sheet do not touch one another within the core, so that within the core the metal sheets form at least one air gap with the core or at a periphery of the core at their respective sheet ends.

In transformer construction, the cores of the transformers are often built as what are known as wound cores that consist of many layers of thin metal sheets that are laid around each other with an offset with respect to one another, or pushed into one another, and form metal sheet windings with at least one cut.

One leg of the wound cores passes through the transformer windings. Multiple wound cores can be arranged next to one another or around one another. In some types of core, the “Unicore single” type for example, the wound cores are first disassembled manually into individual “books” as they are known, in order then to be placed manually, book by book, through the ready-prepared transformer windings. Such a manufacturing process is performed manually, and can therefore not be carried out economically.

In other types of wound cores, such as for example wound cores of the “Unicore duo” type, the entire core can be separated into two halves, usually U-shaped or V-shaped, wherein each half can be passed through the prefabricated transformer windings from opposite directions, in order then to be brought together into a complete core. Such a core can be fitted automatically through the transformer windings.

At the cuts of the metal sheets of the wound cores, more or less wide air gaps form which present a magnetic resistance that increases with the width, and thereby cause corresponding no-load losses. While wound cores of the “Unicore single” type only have one cut per metal sheet winding, a wound core of the “Unicore duo” type, or a stacked core, has two cuts in each metal sheet winding. The result of this is that higher no-load losses occur with these types. These reduce the efficiency of the transformer. The no-load losses are an important criterion for the selection of a transformer type, in particular in energy distribution networks.

The object achieved by the invention therefore consists in minimizing the no-load losses in the transformers through the lowest possible magnetic resistances.

A core for a transformer comprising a plurality of bent metal sheets is provided. The sheets are all bonded to form a structure that surrounds a core opening and form the core, wherein in each case the sheet ends of each metal sheet do not touch one another within the core, so that within the core the metal sheets form at least one air gap with the core or at a periphery of the core at their respective sheet ends. According to the invention, the core is impregnated or coated at least at the sheet ends of the metal sheets with a lacquer that contains magnetic particles, wherein the impregnation or coating fills at least the air gaps at the sheet ends of the metal sheets.

The impregnation thus fills at least the region of the air gaps between the ends of the metal sheets. As a result of this, the magnetic flux at the transition from one metal sheet, through the air gap filled with magnetic lacquer, to the next metal sheet end does not bulge as much as would be the case without a magnetically permeable filling, that is for example when filled with oil or air. When a core according to the invention is used the magnetic resistance of a transformer is thus reduced. Put in other words, the no-load losses with a core according to the invention are reduced in comparison with those of cores of the prior art.

Preferably the entire core is impregnated or coated with the lacquer containing the magnetic particles. The impregnation or the coating can thus be applied to the core as a whole, whereby the filling factor of the core, and thus the efficiency of the transformer, is improved. The magnetic particles introduced through the impregnation or the coating reduce the magnetic resistance of the core.

The magnetic particles are preferably superparamagnetic iron oxide nanoparticles. Such nanoparticles are so small that they form a suspension with the liquid lacquer, and can thus penetrate with the liquid lacquer even into narrow air gaps of a core.

In one preferred form of embodiment, the lacquer is a polyurethane lacquer. Such a lacquer is characterized by its hardness and its resistance to corrosion. The formation of a suspension with the superparamagnetic iron oxide nanoparticles is also possible with these lacquers.

The lacquer is preferably water-based. Possible environmental problems caused by harmful solvents are also avoided if a water-based lacquer is used.

The core is preferably composed essentially of U-shaped metal sheets that are arranged, pushed into one another, in such a way that the legs of a U-shaped metal sheet are at least partially in contact in each case with a leg of another U-shaped metal sheet, wherein the sections that bond the legs of these two metal sheets together are positioned lying opposite one another. Expressed in other words, the core is preferably a core of the “Unicore duo” type, or of the “Tranco” type. The impregnation or the coating of such core types with a lacquer containing magnetic particles is particularly preferred, since in this case the no-load losses arising due to the two air gaps of a metal sheet winding can largely be compensated for. The fabrication can furthermore be better automated with this type of core, in particular in that the core can automatically be pushed together. A large amount of manual work is thus avoided, and larger series can be manufactured economically. The manual insertion of “books”, as in the case of the “Unicore single” types, is also omitted here.

In one form of embodiment, also preferred, the metal sheets of the core are each bent around the core opening, wherein the metal sheets are each interrupted at one location by an air gap in such a way that the ends of the metal sheets are arranged aligned opposite to one another at this air gap. Expressed in other words, the core is also preferably implemented as a core of the “Unicore single” type. With a wound core of the “Unicore single” type, in which only one air gap is present in each metal sheet winding, an impregnation again increases the efficiency of the transformer. The technical advantages of this core type for fabrication are retained.

The core is preferably a wound core. Precisely in the case of design as a wound core, the impregnation or coating with the lacquer containing the magnetic particles helps to achieve a significant improvement in the efficiency of the transformer.

The core is preferably a stacked core. Again in the case of stacked cores, the lacquering described above leads to a reduction in the no-load losses. Expressed in other words, the impregnation or the coating is also applicable to stacked cores that have a common air gap extending over the metal sheets. This is filled with the lacquer that contains the magnetic particles, and the efficiency of the transformer thereby increased.

A transformer with a core according to the invention is further advantageously provided.

A method for the manufacture of a transformer is also provided, said transformer comprising a plurality of bent metal sheets that can all be bonded to form a structure that surrounds a core opening and form the core, wherein in each case the sheet ends of each metal sheet do not touch one another within the bonded core. As a result, within the bonded core the metal sheets form at least one air gap with the bonded core or at a periphery of the bonded core at their respective sheet ends. The method according to the invention comprises the following steps: passing the individual metal sheets through at least one transformer winding of the transformer; bonding the individual metal sheets to create the bonded core within the transformer; and impregnation or coating the sheet ends of the metal sheets with a lacquer that contains magnetic particles until the air gaps at the sheet ends of the metal sheets are filled with the lacquer.

The lacquer, furthermore, is preferably sprayed onto the ends of the metal sheets. In such an embodiment, the impregnation or coating of the core can be carried out particularly easily, quickly and economically.

The impregnation or coating of the core according to the invention, furthermore, preferably takes place by spraying the lacquer on to the metal sheets of the core. A cup gun is preferably used for this purpose.

In a dry transformer product, neither a housing nor a selective or complete coating with oil provides protection from corrosion. The impregnation or coating of the entire core of such a transformer with the lacquer containing the magnetic particles here in particular also leads to corrosion protection being provided, since the transformer, as well as its core, can here be exposed to the weather.

Various transformer cores are shown by way of example in the figures. The filling of the air gaps is illustrated schematically, here:

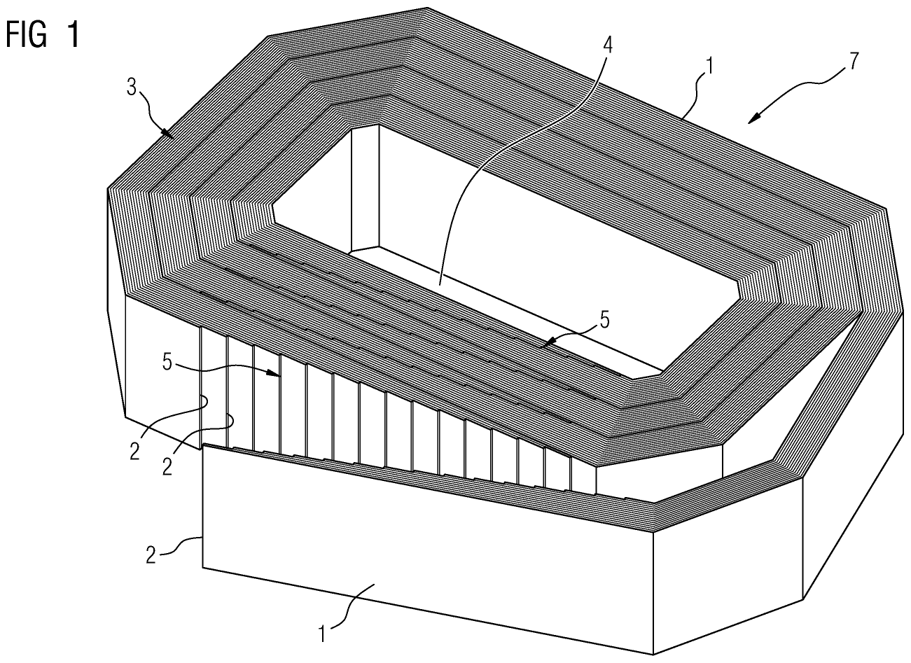

FIG. 1 shows a wound core of the “Unicore single” type;

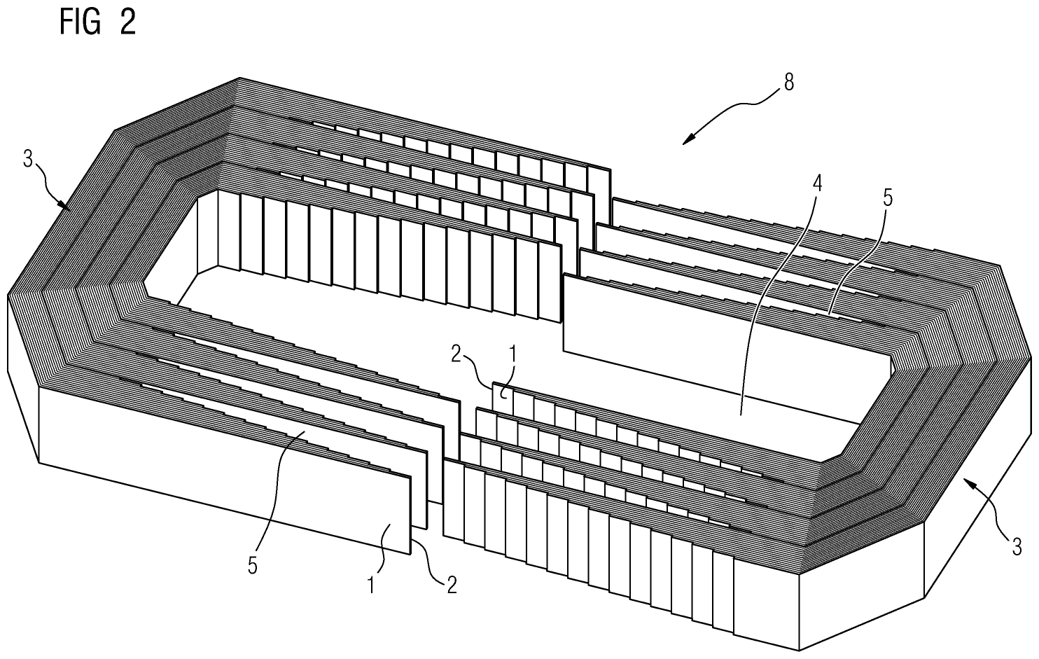

FIG. 2 shows a wound core of the “Unicore duo” type;

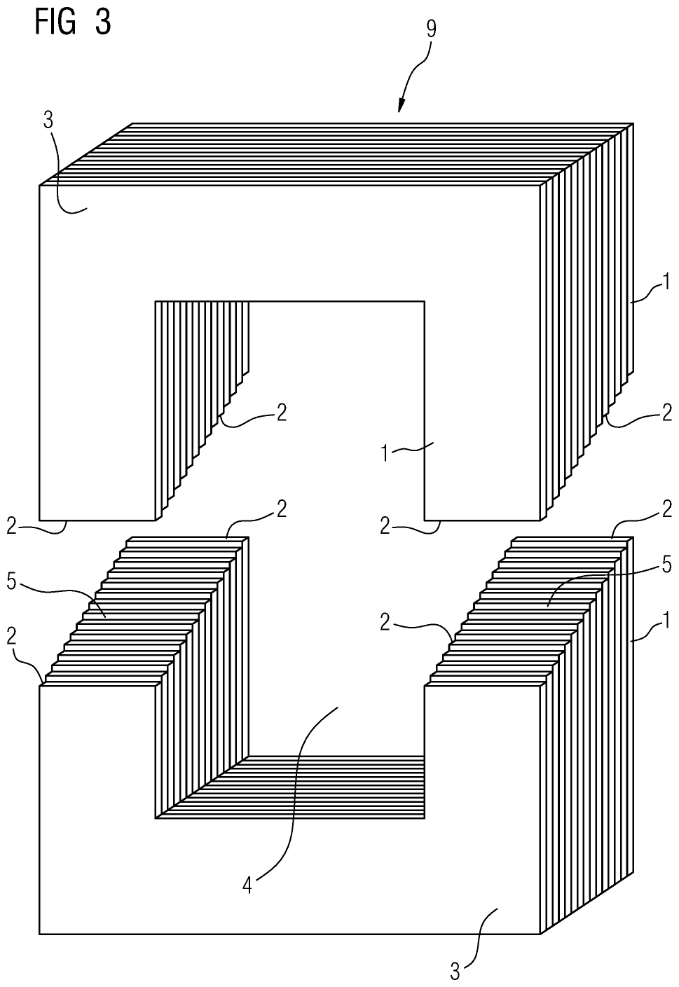

FIG. 3 shows a stacked core;

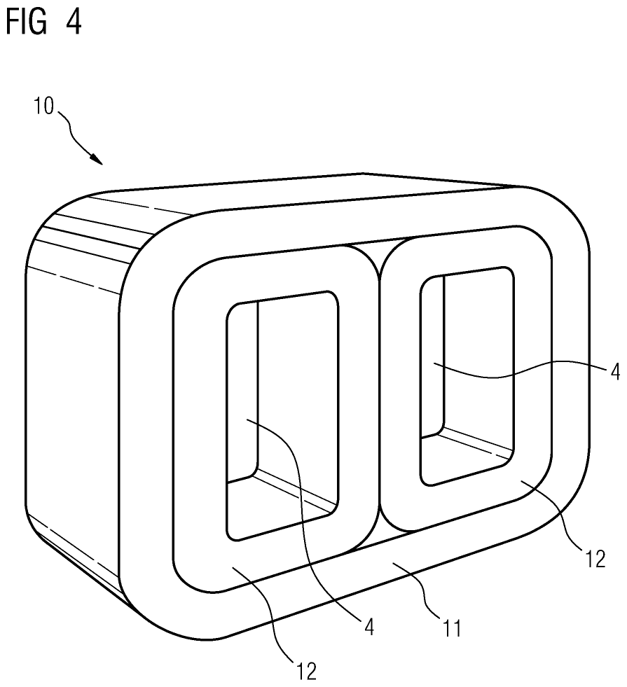

FIG. 4 shows an Evans-core wound core combination of Unicore cores;

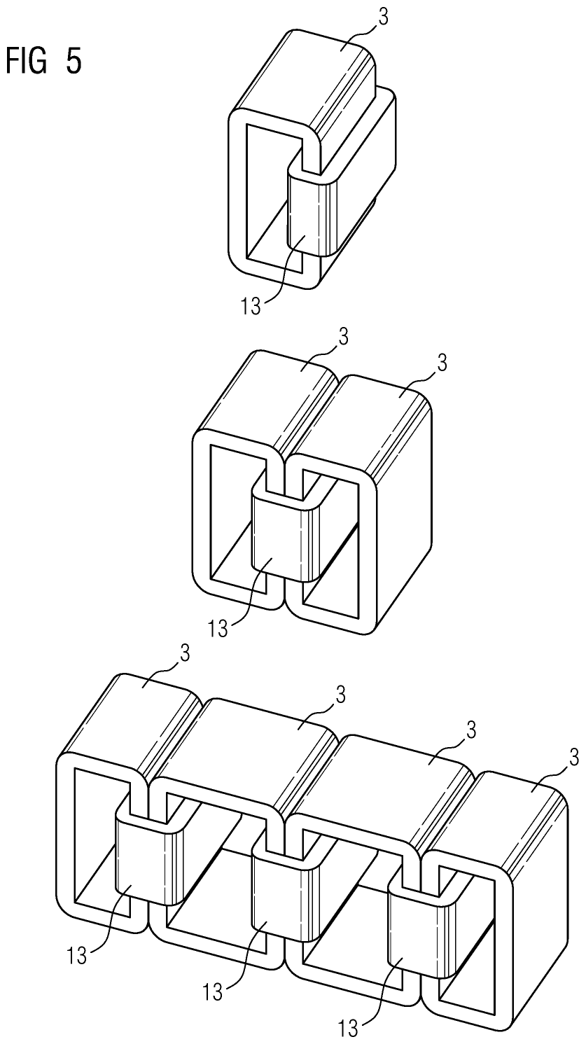

FIG. 5 shows single and multi-phase transformers with wound cores;

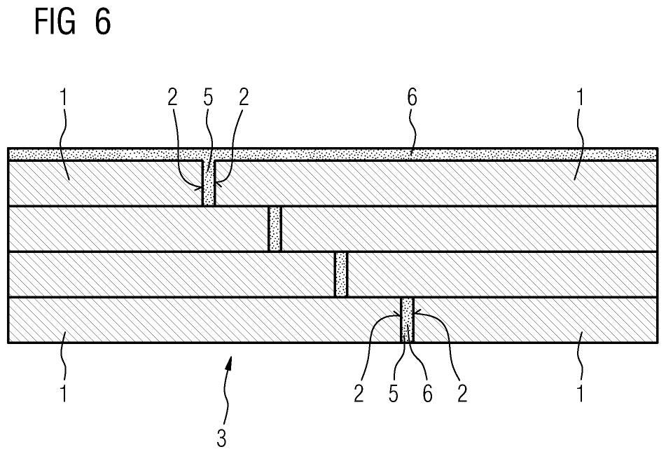

FIG. 6 shows a schematic illustration of the filling of the air gap and the insulation.

FIG. 1 shows a perspective view of an opened, not completely assembled core 3 according to the invention of the “Unicore single” type 7. The metal sheets 1 form the core 3 that is wound around a core opening 4 for a transformer winding. In the assembled state of the core 3, the two sheet ends 2 of a metal sheet 1 butt against one another with a small air gap 5. A filling of the air gap 5 with magnetic particles reduces the magnetic resistance in the respective sheet winding. The sheets 1 of the core 3 are thus each bent around the core opening 4, wherein the sheets 1 are each interrupted at one location by an air gap 5, in such a way that at this air gap 5 the sheet ends 2 are arranged aligned lying opposite one another. Expressed in other words, the sheets 1 are C-shaped in this exemplary embodiment. Described yet again in other words, the sheets 1 each have the shape of a loop interrupted at one location.

FIG. 2 shows a perspective view of a disassembled core 3 according to the invention of the “Unicore duo” type 8. The sheets 1 form the halves of the core 3 that are pushed together around the core opening 4 for a transformer winding. In the assembled state of the core 3, each of the sheet ends 2 of a metal sheet 1 from one half butt with a small air gap 5 against the sheet ends 2 of metal sheets 1 from the other half lying opposite (the regions marked in FIG. 2 as air gap 5 identify those regions of the core halves in which the air gaps 5 result after the core halves have been brought together). With this core type, two gaps 5 are thus present at each sheet winding when in the assembled state. A filling of the air gap 5 with magnetic particles reduces the magnetic resistance in the respective sheet winding. Expressed in other words, the core 3 in this exemplary embodiment is composed of essentially U-shaped metal sheets 1 which, when the core is in its fully assembled state, are pushed in between one another in such a way that the legs of a U-shaped metal sheet 1 are each at least partially in contact with a leg of another U-shaped sheet 1, wherein the segments that bond the legs of these two metal sheets 1 are positioned lying opposite one another.

A stacked core 9 according to the invention is illustrated schematically in FIG. 3. The core 3, consisting of two halves, forms a core opening 4 for a transformer winding. The core 3 has a plurality of metal sheets 1 stacked on top of one another, whose sheet ends 2 each meet the sheet ends 2 of the other part of the core 3. Thus, when the core 3 is assembled, two air gaps 5 again form, which can be filled with magnetic particles (the regions marked in FIG. 5 as air gap 5 identify those regions of the core halves in which the air gaps 5 result after the core halves have been brought together). With this type of core again, the magnetic resistance of the transformer is reduced and the efficiency increased through the impregnation or coating described.

FIG. 4 shows a perspective view of an assembled wound core combination that is identified as an “Evans core”, i.e. as the “Evans core” 10. The Evans core comprises a plurality of Unicore cores. The two inner wound cores have the core openings 4 for transformer windings. The outer wound core 11 is looped around the two inner wound cores 12. All the wound cores in this core combination consist of one of the core types referred to above, whose efficiency is increased through the impregnation with magnetic particles.

Various combinations of core 3 are shown in FIG. 5. In the first illustration, a transformer winding 13 is located on the core 3. In the second illustration, the transformer winding 13 is looped around two cores 3. In the third illustration, a three-phase transformer with four cores 3 is shown, wherein each transformer winding 13 is looped around two cores 3. In all combinations, the cores 3 can be impregnated in accordance with the embodiment described here, and the field of application of the respective transformer thereby extended.

FIG. 6 shows a schematic cross-sectional illustration through the core 3 according to the invention shown in FIG. 1. The filling of the air gap of this core 3 is shown in particular in FIG. 6. The metal sheets 1 butt with their sheet ends 2 against one another, whereby an air gap 5 forms in each case. These air gaps 5 are filled with the lacquer 6 that contains the magnetic particles. The filled air gaps 5 thus have a lower magnetic resistance, and the no-load losses are thus also reduced. The outer side of the core 3 is, furthermore, impregnated with the lacquer 6 (not shown in FIG. 6) and thereby protects the core 3 against the influence of weather. Such a core 3 is thus in particular advantageously usable with dry transformer products.

Although the invention has been illustrated and described in detail more closely through preferred exemplary embodiments, the invention is not restricted by the disclosed examples, and other variations can be derived from this by the expert without leaving the protective scope of the invention.

### LIST OF REFERENCE SIGNS

1 Metal sheet

2 Sheet end

3 Core

4 Core opening

5 Air gap

6 Lacquer

7 Unicore single

8 Unicore duo

9 Stacked core

10 Evans core

11 Outer wound core

12 Inner wound core

13 Transformer winding

1-12. (canceled)

13. A core for a transformer, the core comprising:
a multiplicity of bent metal sheets being bonded together to form a structure surrounding a core opening and forming the core;
said metal sheets each having sheet ends not touching one another within the core, causing the core with said metal sheets to form at least one air gap at said respective sheet ends within the core or at a periphery of the core; and
a lacquer containing magnetic particles, said lacquer impregnating or coating the core at least at said sheet ends of said metal sheets and said impregnated or coated lacquer filling at least said air gaps at said sheet ends of said metal sheets.

14. The core according to claim 13, wherein said lacquer containing said magnetic particles entirely impregnates or coats the core.

15. The core according to claim 13, wherein said magnetic particles are superparamagnetic iron oxide nanoparticles.

16. The core according to claim 13, wherein said lacquer is a polyurethane lacquer.

17. The core according to claim 13, wherein said lacquer is a water-based lacquer.

18. The core according to claim 13, wherein:
said metal sheets are U-shaped and have legs and segments interconnecting said legs; and
said U-shaped metal sheets are pushed into one another with said legs of each of said U-shaped metal sheets being at least partially in contact with a leg of another respective one of said U-shaped metal sheets and with said segments positioned opposite one another.

19. The core according to claim 13, wherein:
said metal sheets are each bent around said core opening;
said metal sheets are each interrupted at one respective location by a respective one of said air gaps; and
said sheet ends are aligned opposite one another at said respective air gap.

20. The core according to claim 13, wherein the core is a wound core.

21. The core according to claim 13, wherein the core is a stacked core.

22. A transformer, comprising a core according to claim 13.

23. A method for manufacturing a transformer including a multiplicity of bent metal sheets being bonded together to form a structure surrounding a core opening and forming the core, each of the metal sheets having sheet ends not touching one another within the bonded core, causing the core with the metal sheets to form at least one air gap at the respective sheet ends within the core or at a periphery of the core, the method comprising:
passing individual metal sheets through at least one transformer winding of the transformer;
bonding the individual metal sheets to create the bonded core within the transformer; and
impregnating or coating the sheet ends of the metal sheets with a lacquer containing magnetic particles until filling the air gaps at the sheet ends of the metal sheets with the lacquer.

24. The method according to claim 23, which further comprises spraying the lacquer on to the sheet ends.
